(19) United States
(12) Patent Application Publication
(10) Pub. No.: US 2014/0279522 A1
(43) Pub. Date: Sep. 18, 2014

(54) MEANS OF AUTHENTICATING A CONSUMER USING DEMAND DEPOSIT ACCOUNT DATA

(71) Applicant: MASTERCARD INTERNATIONAL INCORPORATED, Purchase, NY (US)

(72) Inventors: Paul Michael Musser, Pilot Hill, CA (US); Matthew John Challingsworth, Greystanes (AU); David Aaron Laskin, Purchase, NY (US)

(73) Assignee: MASTERCARD INTERNATIONAL INCORPORATED, Purchase, NY (US)

(21) Appl. No.: 13/839,579

(22) Filed: Mar. 15, 2013

(51) Int. Cl. G06Q 20/40

(52) U.S. Cl. CPC G06Q 20/401
USPC 705/44

(57) ABSTRACT

Authenticating a device holder using a payment device. The method comprises receiving identifying information related to a payment device from a device holder to be authenticated. A data repository is solicited for transactional information related to an account drawn upon by the payment device. One or more challenge questions are presented to the device holder to be authenticated, the challenge questions being related to the transactional information. The device holder to be authenticated responds to the one or more challenge questions. Based on the responses, it is determined whether at least a predetermined number of the responses to the one or more challenge questions corresponds with the transactional information. The device holder may be authenticated based upon the determining that at least a predetermined number of the responses to the one or more challenge questions correspond with the transactional information.

### BACKGROUND

1. Field of the Disclosure

The present disclosure relates to electronic commerce. More specifically, the present disclosure is directed to method and system for authenticating the identity of a user with reference to data that the user is likely to have, but an impersonator is not likely to have.

2. Brief Discussion of Related Art

Traditionally, a user of a payment card- or payment device (generally hereinafter, ‘cardholder’) attempting to use a payment card or device as payment in a cashless transaction would authenticate themselves by providing a signature, which is compared to a reference signature, for example provided on the reverse of the payment card itself. In some circumstances, the payor may be asked to present supplemental identification documents (e.g., government issued credentials, such as driver's license or passport). For simplicity, the payment device is discussed as a credit card, although those skilled in the art will appreciate the present disclosure is equally applicable to any cashless payment device, for example and without limitation contactless RFID-enabled devices including smart cards, NFC-enabled smartphones, electronic mobile wallets or the like. The credit card here is emblematic of any transaction device, real or virtual, by which the device holder as payor and/or the source of funds for the payment may be identified.

There are many circumstances in electronic commerce transactions where the card (or device) holder, and therefore the device, is not present before the merchant at the time the transaction is consummated. This is described as a so-called Card Not Present (CNP) transaction. Because the cardholder need not attend a CNP transaction, such transactions figure in a disproportionate number of abuse cases involving fraud and theft. Therefore, for CNP transaction, additional steps to verify the identity of the user may be desirable, to ensure that the transaction is legitimate. In addition to the verification of user identity in completion of a CNP transaction, it would be beneficial to construct novel ways to verify a user identity, for example before access is given to the user to make changes affecting the user's account, and/or provide information or services to the user concerning the user's credit or debit account.

Regardless of the circumstances, any efforts to increase cardholder security build the cardholder's trust in the processing network, and inures to the benefit of the network operator.

### SUMMARY

Provided according to the present disclosure is a method of authenticating a device holder using a payment device. The method comprises receiving identifying information related to a payment device from a device holder to be authenticated. A data repository is solicited for transactional information related to an account drawn upon by the payment device. One or more challenge questions are presented to the device holder to be authenticated, the challenge questions being related to the transactional information. The device holder to be authenticated responds to the one or more challenge questions. Based on the responses, it is determined whether at least a predetermined number of the responses to the one or more challenge questions corresponds with the transactional information. The device holder may be authenticated based upon the determining that at least a predetermined number of the responses to the one or more challenge questions correspond with the transactional information.

In a further embodiment of the disclosed method, the data repository is operated by an issuing financial institution that issued the payment device, and that maintains an account which funds the payment device. In that case, soliciting transactional information comprises sending to the financial institution at least one of a BANKNET inquiry for transaction data, a Merchant Data Service network inquiry for transaction data, or an ATM mini-statement request.

In a further embodiment of the disclosed method, the data repository comprises a record of transactions engaged using the payment device maintained by an entity operating the network of cashless transaction processing.

In a further embodiment of the disclosed method, steps include soliciting and receiving, from the data repository, a validation of the identifying information related to the payment device.

Optionally, determining whether at least a predetermined number of the responses to the one or more challenge questions corresponds with the transactional information may optionally include an allowance for a maximum threshold of incorrect responses to the one or more challenge questions. Determining whether at least a predetermined number of the responses to the one or more challenge questions corresponds with the transactional information may optionally include accepting a response indicating a range of numeric data that includes the corresponding transaction data as corresponding with the transaction data.

Responsive to authenticating the device holder to be authenticated, the method may optionally proceed with an interaction with the device holder related to the payment device. Such interactions may include a purchase transaction, or obtaining access to a card-related product or service, reporting a lost or stolen payment card, without limitation.

Still further disclosed herein is an electronic system including a processor, and a machine-readable storage medium. The storage medium carries thereon a program of instructions which, when executed by the processor, cause the processor to carry out a method having the features and characteristics described above. Moreover, the present disclosure contemplates a storage medium itself embodying thereon such a program of instruction.

These and other purposes, goals and advantages of the present disclosure will become apparent from the following detailed description of example embodiments read in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a functional schematic diagram depicting a customer interaction for CNP verification according to an embodiment of the present disclosure;

FIG. 2A illustrates a first method to obtain the transactional information from a financial institution used to validate the cardholder;

FIG. 2B illustrates a second method to obtain the transactional information from a financial institution used to validate the cardholder;

FIG. 2C illustrates a third method to obtain the transactional information from a financial institution used to validate the cardholder;

FIG. 2D illustrates still another method to obtain transactional information used to validate the cardholder from a transaction processor;

FIG. 2e illustrates still another method to obtain transactional information used to validate the cardholder from a third-party transaction processor; and

FIG. 3 illustrates schematically a representative computer according to the present disclosure, operative to implement the disclosed methods.

### DETAILED DESCRIPTION

In order to increase the level of security on debit products while providing value-add features, the present disclosure provides a novel form of personal authentication at the service level to increase card holder and card issuer trust during card not present (CNP) transactions. Referring now to FIG. 1, illustrated is a functional schematic diagram depicting a customer interaction, generally 100, for CNP verification according to an embodiment of the present disclosure.

In the interaction 100, the cardholder 102 engaged in a communication with an electronically hosted platform 104. Generally, this communication will entail internet web-based communication from the cardholder's 102 home or office, but may also include interaction with a remote kiosk (not shown) that is in communication with the platform 104. The cardholder 102 is first presented with a generic welcome or home page 106, i.e., one which is presented to all visitors or entrants of the platform 104. From the home page 106, the cardholder 102 makes a selection that they wish to engage in an interaction related to their payment card (e.g., purchase transaction, obtain services related to their card account, etc.). In response to this indication from the cardholder 102, the platform 104 presents the cardholder with a validation page 108.

At the validation page 108, the cardholder 102 is requested to provide the relevant information from and relating to their payment card, including without limitation: the account number associated with the card (aka, the primary account number or PAN); the expiration date of the card; a card validation code (CVC) string, which is typically, but need not exclusively be, a numeric string; billing address or billing zip code of the associated account; etc. This payment card-related information is passed by the platform 104 to a data engine 110. The data engine 110 may be considered part of a back-end—i.e., not directly visible to the cardholder 102—of the platform 104, for example where the platform is hosted by the card payment services network operator. Alternately, the data engine 110 may represent a service provided to an operator of the platform 104, for example where the platform is an e-commerce site operated by a merchant accepting the payment card for transactions, the data engine 110 is serviced by the card payment services network operator. The data engine 110 carries out the necessary interactions to verify the identity of the cardholder as described further herein.

The deliverable from the data engine 110 to the platform 104 are two-fold. First, the data engine 110 is to, by one or more of the techniques described herein, or others as may be or come to be known, confirm the validity of the PAN and associated information as provided by the cardholder 102, and further to provide information derived from the account associated with the PAN given, as part of a challenge-response verification of the cardholder 102 identity. The data engine 110 may obtain the necessary information in one of a number of ways, as described hereinafter.

Having obtained the deliverable information, the case where the PAN or any associated card information is invalid 112 can result in an error message returned to the cardholder 102 via the validation page 108. If information was inadvertently mistyped, etc., the cardholder 102 may try again to enter the correct information. Certain limitations on a permissible number of failed attempts, in a given time frame, from a given IP address, etc., or some combination of these and/or other security features, may be employed. Alternately or additionally, e.g., after exceeding permissible number of failed attempts based, the validation may be terminated at 124. In some cases, the termination may be opaque to the cardholder 102 as to the precise reason for the termination.

On the other hand, where the data engine 110 receives confirmation of the validity 114 of the PAN, the data engine 110 will also have requested and received from the issuing institution a sample of transactional data associated with the underlying account. Such transaction data may include, without limitation, the date, time and/or merchant involved with some predetermined number of transactions. Other transaction data may include a day and amount of last payment or deposit on the account, or the account balance on a given date. The data engine 110 passes the PAN validity confirmation 114 along with the transactional data to the platform 104. The platform 104 then uses the transactional data as the basis for a challenge/response test 116, presented to the cardholder 102 in order to verify the cardholder's identity.

The challenge/response test 116 may use the transactional data in a variety of ways. The cardholder 102 can be asked to verify, either in an open-ended or multiple choice manner, information pertaining to a recent transaction, including without limitation the date, amount, or merchant involved.

For example, presuming the transactional data indicated a purchase from ABC Specialty Store on Mar. 12, 2012 in the amount of $27.50. A sample question might read:
On Mar. 12, 2012, you made a purchase using your MasterCard Debit Card in the amount of $27.50. What is the name of the merchant involved in this transaction?
A) Jane's Clothing Boutique
B) ABC Specialty Store
C) XYZ Supermarket
D) I do not recognize this transaction.
   As here, the offered responses may include a default response (response D, in this case) in order to hold open the possibility that the question is a red herring, i.e., that no such transaction exists. Alternately, the challenge question may inquire about the amount of the purchase while giving the merchant and date (or a fictitious pretext of a transaction to which a response such as D, above, would be appropriate). The challenge question may inquire about the date and time of the most recent payment or deposit to the linked account, or the amount of such payment or deposit. Where the subject of the challenge question is a dollar amount, or some other numeric value (e.g., date), the cardholder 102 may be presented with answers in the form of a range or band of values, one of which may include the correct value.

It will generally be at the discretion of the operator of platform 104, in consultation with the operator of the data engine 110, to determine the level of correct responses required to authenticate the cardholder 102. For example, this will include the number of challenge questions to be answered correctly, a permissible number of incorrect answers, etc. Where the challenge questions present a limited number of possible responses, as in the example above, it is possible that the appropriate answer to any challenge question can be selected by mere chance. Therefore, there is an advantage in terms of the strength and reliability of the authentication to require a minimum number of challenge questions be answered correctly in order to be authenticated. Generally speaking, the probability that a series of challenge questions with a finite number of possible responses, if answered randomly, will result in all appropriate responses is equal to one chance in x raised to the power of y, where x is the number of possible answers to each question presented, and y is the minimum number of correct answers. For example, if there are four possible answers to each challenge question and a minimum of four questions must be answered correctly to authenticate the cardholder 102, then there is a one in 256 (4⁴) chance of guessing all four questions correctly, 0.39%. Allowance for at least one incorrect answer, i.e. requiring only 3 correct answers, would increase the probability that a series of random guesses will result in an authentication to 1.6%, or one in 64 (4³). However, considering that a sufficient number of correct answers must be received before a threshold number of incorrect answers (for the sake of this example, one) is exceeded, the amount by which that probability increases is further limited.

It is generally considered that there will be one of three outcomes of the challenge/response question 116. In a first instance, the response to challenge questions will meet the required threshold for successful validation 118. The cardholder 102 may provide a response to a challenge question 120, where additional questions are needed to complete the validation. It may be that the response was correct, but more correct responses are necessary to achieve a minimum threshold for verification. Alternately, the response may be incorrect, but within a tolerance (if any) of permissible incorrect answers. Alternately, the cardholder 102 may provide an response to a challenge question, and have also exceeded a tolerance of permissible incorrect answers, if any was established, such that the validation is unsuccessful 122.

Taking these cases retrospectively, if one or more unsuccessful responses to a challenge question indicate beyond a threshold level that the user interacting with the platform 104 cannot be validated as the authentic cardholder 102, then the process is terminated 124, in some instances discretely and/or opaquely to the user interacting with the platform 104. The user may be returned to the home page 106. The platform 104 may or may not afford the same user another opportunity to validate themselves with the same or alternate credentials.

On the other hand, it may be the case that a response, correct or incorrect, requires and permits additional questions 120 to complete the validation. The user may or may not be apprised that their response was insufficient. From the user point-of-view, it should preferably be opaque as to whether their response was adequate to the challenge. Moreover, from a standpoint of data security, only the minimum necessary transactional information may be released to the operator of the platform 104. It may be the case that an initial data provisioning 114 includes sufficient information to frame a minimum adequate number of challenge/response questions. Thus, if one question is answered incorrectly, it may not be immediately necessary to seek additional transactional data from the data engine 110, as illustrated in FIG. 1 via the broken line path from 120 to 116, including data engine 110.

If the user is within an established tolerance of incorrect answers, then another challenge question may be presented 116. If one or more questions are answered incorrectly, and only a minimum provision of data was supplied, additional information would be needed before completing the validation. In that case, the platform 104 would revert to the data engine 110 from the state of 120, for additional data. Thereafter, the cardholder 102 would be presented with additional challenge/response questions 116, leading to either a successful validation 118, or a rejection of validation 122. Alternately the data may be held securely by the data engine 110. The data engine 110 would supply the challenge questions and a range of answers to the platform 104. The platform 104 in that scenario would pass the responses supplied by the cardholder 102 to the data engine for validation.

Alternately an initial data provision 114 from the data engine 110 might include sufficient information to frame a number of challenge/response questions including allowance for incorrect responses. Additional security measures, for example a prohibition against data storage by the platform 104 following the validation result, and/or direct management of the challenge/response process by operator of the data engine 110, may also be provided.

Finally, upon successful completion of a specified number of challenge/response questions 118, the cardholder 102 is presented with a page that permits them to consummate the interaction 126 for which they began the validation. This may be a purchase transaction, obtaining access to a card-related product or service, reporting a lost or stolen payment card, without limitation. Following the successful consummation of the interaction 126, the cardholder is present with a confirmation of their successful completion 128.

We turn now to the acquisition by the data engine 110 of the transaction data to be provisioned to the platform 104. Referring to FIGS. 2A and 2B, illustrated are first and second methods, respectively, for the data engine 110 to obtain the necessary information. There are essentially two parallel systems for processing purchase card (i.e., credit or debit) transactions. The first, represented in FIG. 2A, is the BANKNET authorization system. By way of background, the BANKNET system is characterized by its use of two sequential messages in order to consummate any given transaction. The first message is an authorization message, which seeks an authorization to complete a given transaction from the institution holding the account on which the card is issued. The response to the authorization is passed on to the merchant, for example. A second message is sent to ‘clear’ the transaction once the merchant has provided the goods or services bargained for, and initiates the transfer of funds according to the previous authorization.

On the other hand, and with reference to FIG. 2B, card transactions may be processed through a parallel and competing payment network known as Merchant Data Service (MDS). The MDS network is characterized in that transactions are processed in a single transaction message and response (e.g., approve or decline), rather than two messages as described above with reference to the BANKNET system depicted in FIG. 2A.

In both use cases, FIGS. 2A and 2B, the message protocol may be configured to allow the message from data engine 110 to be of an inquiry nature, rather than a message seeking to initiate a transaction on the account. Moreover, the communication protocol further provides for data to be requested, for example as part of the authorization inquiry, with the response message from the issuer including the requested payload data. In those circumstances, the message transmitted to the issuing bank, i.e., the entity responsible for issuing the payment card and which also holds the credit or demand deposit account on which the payment card draws, via either the BANKNET or MDS systems, as applicable to the particular issuer.

The inquiry message 202a, 202b, from the data engine 110 will be of an inquiry nature only, i.e., not of a type initiating a transaction. The inquiry message 202a, 202b is routed through the MasterCard Interface Processor (MIP) e.g., 220a, 220b, where the payment card is a MasterCard brand—the process being analogous or equivalent for other brands of credit card as well. The inquiry message 202a, 202b from the data engine 110 is routed by the issuer card management system, e.g., 220a, 220b. The inquiry message 202a, 202b will include a request from the data storage 204a or 204b for recent transaction data on the account, e.g., of the most recent transactions (choosing five, for the sake of illustration, more or less being within the scope of the present disclosure), the transaction date, the transaction type (purchase, return, deposit, payment, etc.), the merchant entity, if applicable. The response from to the data engine 110 inquiry message the issuer will preferably include the requested payload transactional data. This transactional data is then passed to the platform 104 by the data engine 110 to formulate the challenge/response questions as described above.

The foregoing discussion of FIGS. 2A, 2B presumes that the particular issuer is configured to receive and respond to such requests for transactional information in the transaction data stream. Because the transaction processing system is backwards compatible, not all issuers are rigorously current with the most recent protocols and capabilities, including inquiries for payload data as described. In that case, other means of obtaining the verification information are contemplated.

To that end, we turn to FIG. 2C. FIG. 2C, illustrates is still another embodiment for obtaining the requisite transaction data for verifying cardholder 102 identity. In this case, the financial institution is not operating under protocols outlined in either FIG. 2A or 2B above, but does allow ATM interaction with the account, for example to permit balance inquiries or cash withdrawals. Many such institutions are configured to provide so-called mini-statements upon request. A mini-statement includes an account balance, and a précis of transaction detail for some predetermined range of transactions on the account, e.g., previous five transactions, or up to 7 transactions in the last 90 days, or the like. Transactions may include charges, refunds, credits, deposits, withdrawals, payments, etc.

Therefore, the data engine 110 is optionally enabled to issue a request 206 for a mini-statement to the financial institution. That request 206 is likewise routed through a MIP 220c, and likewise handled by the issuer's card management system 222c. The data requested, drawn from the data storage 204c, is included in the responsive mini-statement. That mini-statement data then forms the basis of the challenge and response questions presented to the cardholder 102.

The financial institution holding a given account is the preferred source for transactional data, in part because it will have the most up-to-date information concerning the account, and may have information not available to the network operator or a third-party intermediary (payment or deposit data on a credit or debit account, respectively, for example). One advantage this provides is for additional types of data, and further that most recent transactions will be fresh in the mind of the cardholder 102, giving the cardholder 102 the best opportunity to avoid an incorrect answer that might result in a false-negative denial of access, simply because they do not remember the transaction embodied a given question.

However, in the case that the requisite transaction data is not available from the issuer on the corresponding account, the network operator may look to other resources. Illustrated in FIGS. 2D, 2E are a fourth and fifth method, respectively, to obtain the transaction data to perform the validation sought herein. In consideration of FIGS. 2D, 2E, it may be the case that the financial institution holding the demand deposit account or line of credit account that funds the particular PAN is for any number of reasons, whether intermittent or continuing, unable to provide the necessary information to compose verification challenge and response questions.

In its capacity as operator of a cashless transaction facilitation network, the network operator (which the instant Assignee is one) has access to transaction data related to card-based transactions. A network operator may maintain a data warehouse including a historical record of such transactions. Therefore, where the financial institution maintaining the account underlying the transaction is not the source of the necessary data, with reference to FIG. 2D, the network operator may look to its own data warehouse for a selection of transactions associated with the PAN involved in the present verification. In other respects, the process proceeds as if the issuing financial institution were providing the data. The query 208 of the data warehouse 210 will verify the validity of the PAN, as well as provide the necessary transactional data to perform the cardholder 102 validation.

Turning then to FIG. 2E, illustrated is the case where the network operator itself does not intermediate transactions, for example in certain international jurisdictions under local law. In any event, there is a third-party intermediary, who likewise maintains a data warehouse of transaction data. Therefore, the use case of FIG. 2E is largely analogous to that of FIG. 2D, except that it involves a query 212 issue to a third-party source of stored transaction data 214.

In any of the foregoing embodiments, it will be to the advantage of the network operator to maintain a reference or table of which financial institutions are responsive to which of the foregoing methods, if any, of obtaining the required transaction data. The financial institution will be identifiable from the Bank Identification Number (BIN), which forms a part of the PAN for each card account. The data engine would be enabled, by consultation with the reference or table, issue the appropriate request, whether to the financial institution as according to FIG. 2A, 2B or 2C; to an internal data warehouse as according to FIG. 2D, or to a third party as according to FIG. 2E. It is also contemplated that the methods disclosed herein are not mutually exclusive of one another, and may be used in combination. For example, if an inquiry to the issuing financial institution fails due to a communication breakdown between the data engine 110 and the issuer, then the network operator may revert to other sources of data, e.g., those described with respect to FIGS. 2D and/or 2E.

It will be appreciated by those skilled in the art that the methods as described above may be operated by a machine operator having a suitable interface mechanism, and/or more typically in an automated manner, for example by operation of a network-enabled computer system including a processor executing a system of instructions stored on a machine-readable medium, RAM, hard disk drive, or the like. The instructions will cause the processor to operate in accordance with the present disclosure.

Turning then to FIG. 3, illustrated schematically is a representative computer 616 of the system 600. The computer 616 includes at least a processor or CPU 622 which is operative to act on a program of instructions stored on a computer-readable medium 624. Execution of the program of instruction causes the processor 622 to carry out, for example, the methods described above according to the various embodiments. It may further or alternately be the case that the processor 622 comprises application-specific circuitry including the operative capability to execute the prescribed operations integrated therein. The computer 616 will in many cases includes a network interface 626 for communication with an external network 612. Optionally or additionally, a data entry device 628 (e.g., keyboard, mouse, trackball, pointer, etc.) facilitates human interaction with the server, as does an optional display 630. In other embodiments, the display 630 and data entry device 628 are integrated, for example a touch-screen display having a GUI.

Variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/we claim:

1. A method of authenticating a device holder using a payment device, the method comprising:
receiving identifying information related to a payment device from a device holder to be authenticated;
soliciting, from a data repository, transactional information related to an account drawn upon by the payment device;
presenting one or more challenge questions to the device holder to be authenticated, the one or more challenge questions being related to the transactional information;
receiving, from the device holder to be authenticated, responses to the one or more challenge questions;
determining whether at least a predetermined number of the responses to the one or more challenge questions corresponds with the transactional information; and
authenticating the device holder to be authenticated based upon the determining that at least a predetermined number of the responses to the one or more challenge questions corresponds with the transactional information.

2. The method according to claim 1, wherein the data repository is operated by an issuing financial institution that issued the payment device, and that maintains an account which funds the payment device.

3. The method according to claim 2, wherein soliciting transactional information comprises sending to the financial institution at least one of a BANKNET inquiry for transaction data, a Merchant Data Service network inquiry for transaction data, or an ATM mini-statement request.

4. The method according to claim 1, wherein the data repository comprises a record of transactions engaged using the payment device maintained by an entity operating the network of cashless transaction processing.

5. The method according to claim 1, further comprising soliciting and receiving, from the data repository, a validation of the identifying information related to the payment device.

6. The method according to claim 1, wherein determining whether at least a predetermined number of the responses to the one or more challenge questions corresponds with the transactional information comprises an allowance for a maximum threshold of incorrect responses to the one or more challenge questions.

7. The method according to claim 1, wherein determining whether at least a predetermined number of the responses to the one or more challenge questions corresponds with the transactional information comprises accepting a response indicating a range of numeric data that includes the corresponding transaction data as corresponding with the transaction data.

8. The method according to claim 1, further comprising proceeding with an interaction with the device holder related to the payment device responsive to authenticating the device holder to be authenticated.

9. A non-transitory machine-readable storage medium, having thereon a program of instruction which, when executed by processor, cause the processor to:
receive identifying information related to a payment device from a device holder to be authenticated;
solicit, from a data repository, transactional information related to an account drawn upon by the payment device;
present one or more challenge questions to the device holder to be authenticated, the one or more challenge questions being related to the transactional information;
receive, from the device holder to be authenticated, responses to the one or more challenge questions;
determine whether at least a predetermined number of the responses to the one or more challenge questions corresponds with the transactional information; and
authenticate the device holder to be authenticated based upon the determining that at least a predetermined number of the responses to the one or more challenge questions corresponds with the transactional information.

10. The non-transitory machine-readable storage medium according to claim 9, wherein the program of instruction, when executed by processor, further cause the processor to:
solicit the transactional information from a data repository operated by an issuing financial institution that issued the payment device, and that maintains an account which funds the payment device.

11. The non-transitory machine-readable storage medium according to claim 10, wherein soliciting transactional information comprises sending to the financial institution at least one of a BANKNET inquiry for transaction data, a Merchant Data Service network inquiry for transaction data, or an ATM mini-statement request.

12. The non-transitory machine-readable storage medium according to claim 9, wherein the data repository comprises a record of transactions engaged using the payment device maintained by an entity operating the network of cashless transaction processing.

13. The non-transitory machine-readable storage medium according to claim 9, wherein the program of instruction, when executed by processor, further cause the processor to:
solicit and receive, from the data repository, a validation of the identifying information related to the payment device.

14. The non-transitory machine-readable storage medium according to claim 9, wherein determining whether at least a predetermined number of the responses to the one or more challenge questions corresponds with the transactional information comprises an allowance for a maximum threshold of incorrect responses to the one or more challenge questions.

15. The non-transitory machine-readable storage medium according to claim 9, wherein determining whether at least a predetermined number of the responses to the one or more challenge questions corresponds with the transactional information comprises accepting a response indicating a range of numeric data that includes the corresponding transaction data as corresponding with the transaction data.

16. The non-transitory machine-readable storage medium according to claim 9, wherein the program of instruction, when executed by processor, further cause the processor to:
proceed with an interaction with the device holder related to the payment device responsive to authenticating the device holder to be authenticated.

17. A system for monitoring cashless transaction data, the system comprising:
a computer including a processing device and a non-transitory, machine-readable storage medium, having thereon a program of instruction which, when executed by processor, cause the processor to:
receive identifying information related to a payment device from a device holder to be authenticated;
solicit, from a data repository, transactional information related to an account drawn upon by the payment device;
present one or more challenge questions to the device holder to be authenticated, the one or more challenge questions being related to the transactional information;
receive, from the device holder to be authenticated, responses to the one or more challenge questions;
determine whether at least a predetermined number of the responses to the one or more challenge questions corresponds with the transactional information; and
authenticate the device holder to be authenticated based upon the determining that at least a predetermined number of the responses to the one or more challenge questions corresponds with the transactional information.

18. The system according to claim 17, wherein the program of instruction, when executed by processor, further cause the processor to:
solicit the transactional information from a data repository operated by an issuing financial institution that issued the payment device, and that maintains an account which funds the payment device.

19. The system according to claim 17, wherein soliciting transactional information comprises sending to the financial institution at least one of a BANKNET inquiry for transaction data, a Merchant Data Service network inquiry for transaction data, or an ATM mini-statement request.

20. The system according to claim 17, wherein the data repository comprises a record of transactions engaged using the payment device maintained by an entity operating the network of cashless transaction processing.

21. The system according to claim 17, wherein the program of instruction, when executed by processor, further cause the processor to:
solicit and receive, from the data repository, a validation of the identifying information related to the payment device.

22. The system according to claim 17, wherein determining whether at least a predetermined number of the responses to the one or more challenge questions corresponds with the transactional information comprises an allowance for a maximum threshold of incorrect responses to the one or more challenge questions.

23. The system according to claim 17, wherein determining whether at least a predetermined number of the responses to the one or more challenge questions corresponds with the transactional information comprises accepting a response indicating a range of numeric data that includes the corresponding transaction data as corresponding with the transaction data.

24. The system according to claim 17, wherein the program of instruction, when executed by processor, further cause the processor to:
proceed with an interaction with the device holder related to the payment device responsive to authenticating the device holder to be authenticated.
